(19) United States
(12) Patent Application Publication
(10) Pub. No.: US 2006/0287865 A1
(43) Pub. Date: Dec. 21, 2006

(54) Establishing a multimodal application voice

(76) Inventors: Charles W. Cross JR., Wellington, FL (US); Michael C. Hollinger, Memphis, TN (US); Igor R. Jablokov, Charlotte, NC (US); Benjamin D. Lewis, Ann Arbor, MI (US); Hilary A. Pike, Austin, TX (US); Daniel M. Smith, Raleigh, NC (US); David W. Wintermute, Boynton Beach, FL (US); Michael A. Zaitzeff, Carson City, NV (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/154,900

(22) Filed: Jun. 16, 2005

(51) Int. Cl. G10L 21/00

(52) U.S. Cl. 704/275

(57) ABSTRACT

Establishing a multimodal application voice including selecting a voice personality for the multimodal application and creating in dependence upon the voice personality a VoiceXML dialog. Selecting a voice personality for the multimodal application may also include retrieving a user profile and selecting a voice personality for the multimodal application in dependence upon the user profile. Selecting a voice personality for the multimodal application may also include retrieving a sponsor profile and selecting a voice personality for the multimodal application in dependence upon the sponsor profile. Selecting a voice personality for the multimodal application may also include retrieving a system profile and selecting a voice personality for the multimodal application in dependence upon the system profile.

### BACKGROUND OF THE INVENTION

1. Field of the Invention

The field of the invention is data processing, or, more specifically, methods, systems, and products for establishing a multimodal application voice.

2. Description Of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through other modes, such as multimodal access. Devices which support multimodal access combine multiple user input modes or channels in the same interaction allowing a user to interact with the multimodal applications on the device simultaneously through multiple input modes or channels. The methods of input include speech recognition, keyboard, touch screen, stylus, mouse, handwriting, and others. Multimodal input often makes using a small device easier.

Multimodal applications often run on servers that serve up multimodal web pages for display on a multimodal browser. A ‘multimodal browser,’ as the term is used in this specification, generally means a web browser capable of receiving multimodal input and interacting with users with multimodal output. Multimodal browsers typically render web pages written in XHTML+Voice (X+V).

X+V provides a markup language that enables users to interact with a multimodal application often running on a server through spoken dialog in addition to traditional means of input such as keyboard strokes and mouse pointer action. X+V adds spoken interaction to standard web content by integrating XHTML (extensible Hypertext Markup Language) and speech recognition vocabularies supported by Voice XML. For visual markup, X+V includes the XHTML standard. For voice markup, X+V includes a subset of VoiceXML. For synchronizing the VoiceXML elements with corresponding visual interface elements, X+V uses events. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

Typical multimodal applications interact with users using a standardized voice despite without regard to the particular user, timing and location conditions, or other factors that may affect the quality of the interaction between the user and the multimodal application. The particular voice features of a multimodal application however are dictated by various aspects of voice markup and are therefore variable. There is therefore a need for establishing a multimodal application voice that may be custom tailored to users and user conditions.

### SUMMARY OF THE INVENTION

More particularly, exemplary methods, systems, and products are disclosed for establishing a multimodal application voice including selecting a voice personality for the multimodal application and creating in dependence upon the voice personality a VoiceXML dialog. Selecting a voice personality for the multimodal application may also include retrieving a user profile and selecting a voice personality for the multimodal application in dependence upon the user profile. Selecting a voice personality for the multimodal application may also include retrieving a sponsor profile and selecting a voice personality for the multimodal application in dependence upon the sponsor profile. Selecting a voice personality for the multimodal application may also include retrieving a system profile and selecting a voice personality for the multimodal application in dependence upon the system profile.

Creating in dependence upon the voice personality a VoiceXML dialog may also include selecting in dependence upon the voice personality an aural style sheet. Creating in dependence upon the voice personality a VoiceXML dialog may also include selecting in dependence upon the voice personality a grammar. Creating in dependence upon the voice personality a VoiceXML dialog may also include selecting in dependence upon the voice personality a language model.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of servers and client devices each of which is capable of supporting a multimodal application.

FIG. 2 sets forth a block diagram of automated computing machinery comprising an exemplary server capable of establishing a multimodal application voice.

FIG. 3 sets forth a block diagram of automated computing machinery comprising an exemplary client that supports a multimodal browser.

FIG. 4 sets forth a flow chart illustrating an exemplary method for establishing a multimodal application voice.

FIG. 5 sets forth a flow chart illustrating an exemplary method for selecting a voice personality.

FIG. 6 sets forth a flow chart illustrating another exemplary method for selecting a voice personality.

FIG. 7 sets forth a flow chart illustrating another exemplary method for selecting a voice personality.

FIG. 8 sets forth a flow chart illustrating another method of selecting a voice personality.

FIG. 9 sets forth a flow chart illustrating an exemplary method for creating in dependence upon the voice personality a VoiceXML dialog.

### DETAILED DESCRIPTION OF EXEMPLARY EMBODIMENTS

### Introduction

The present invention is described to a large extent in this specification in terms of methods for establishing a multimodal application voice. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### DETAILED DESCRIPTION

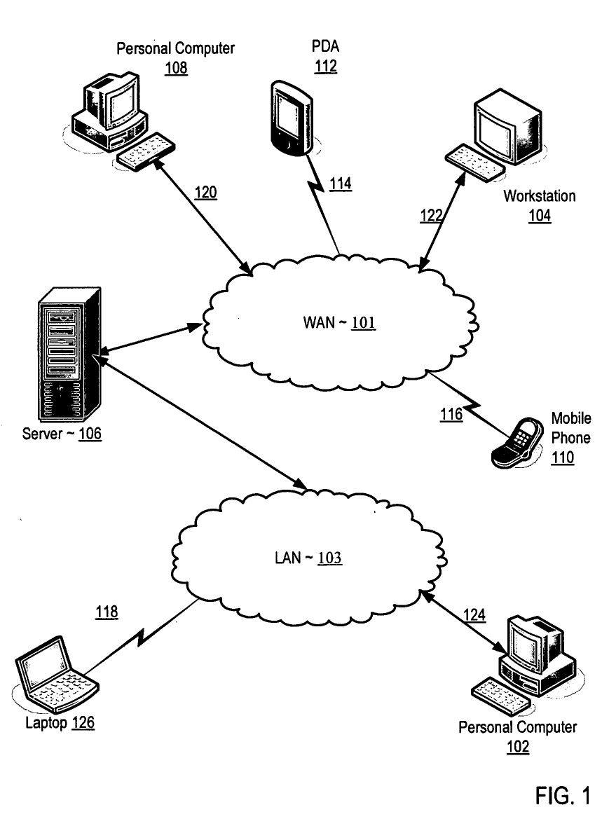

Exemplary methods, systems, and products for establishing a multimodal application voice according to embodiments of the present invention are described with reference to the accompanying drawings, beginning with FIG. 1. FIG. 1 sets forth a network diagram illustrating an exemplary system of servers and client devices each of which is capable of supporting a multimodal application such as multimodal web applications and multimodal web browsers in accordance with the present invention. The system of FIG. 1 includes a number of computers connected for data communications in networks.

The data processing system of FIG. 1 includes wide area network (“WAN”) (101) and local area network (“LAN”) (103). The network connection aspect of the architecture of FIG. 1 is only for explanation, not for limitation. In fact, systems having multimodal applications according to embodiments of the present invention may be connected as LANs, WANs, intranets, intemets, the Internet, webs, the World Wide Web itself, or other connections as will occur to those of skill in the art. Such networks are media that may be used to provide data communications connections between various devices and computers connected together within an overall data processing system.

In the example of FIG. 1, server (106) implements a gateway, router, or bridge between LAN (103) and WAN (101). Server (106) may be any computer capable of accepting a request for a resource from a client device and responding by providing a resource to the requester. One example of such a server is an HTTP (‘HyperText Transport Protocol’) server or ‘web server.’ The exemplary server (106) is capable of serving up multimodal markup documents having an application voice in accordance with the present invention. Such an application voice is established by selecting a voice personality for the multimodal application and creating in dependence upon the voice personality a VoiceXML dialog.

In the example of FIG. 1, several exemplary client devices including a PDA (112), a computer workstation (104), a mobile phone (110), and a personal computer (108) are connected to a WAN (101). Network-enabled mobile phone (110) connects to the WAN (101) through a wireless link (116), and the PDA (112) connects to the network (101) through a wireless link (114). In the example of FIG. 1, the personal computer (108) connects through a wireline connection (120) to the WAN (101) and the computer workstation (104) connects through a wireline connection (122) to the WAN (101). In the example of FIG. 1, the laptop (126) connects through a wireless link (118) to the LAN (103) and the personal computer (102) connects through a wireline connection (124) to LAN (103).

Each of the exemplary client devices (108, 112, 104, 110, 126, and 102) are capable of supporting a multimodal browser coupled for data communications with a multimodal web application on the server (106) and are capable displaying multimodal markup documents dynamically created according to embodiments of the present invention. A ‘multimodal browser,’ as the term is used in this specification, generally means a web browser capable of receiving multimodal input and interacting with users with multimodal output. Multimodal browsers typically render web pages written in XHTML +Voice (X+V).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

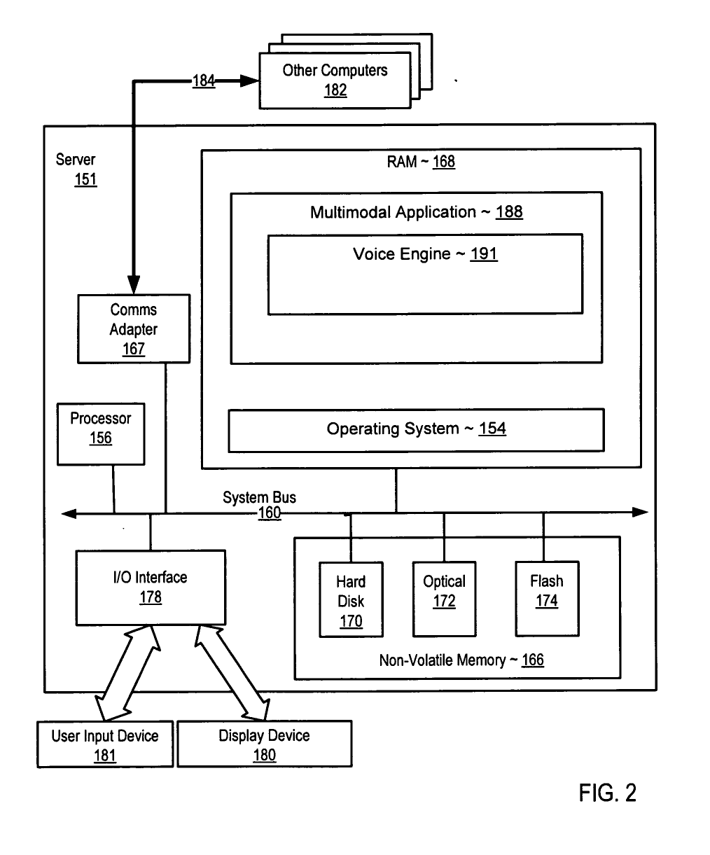

Multimodal applications having a voice established according to embodiments of the present invention are generally implemented with computers, that is, with automated computing machinery. For further explanation, therefore, FIG. 2 sets forth a block diagram of automated computing machinery comprising an exemplary server (151) capable of establishing a multimodal application voice by selecting a voice personality for the multimodal application and creating in dependence upon the voice personality a VoiceXML dialog. A multimodal voice provides the sound and style of speech output of a multimodal application. Such multimodal voices may advantageously be varied according users, sponsors, and system variables and therefore provide user-friendly interaction with users.

The server (151) of FIG. 2 includes at least one computer processor (156) or ‘CPU’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5/OS, and many others as will occur to those of skill in the art.

Also stored in RAM (168) is a multimodal application (188) comprising a voice engine (191) capable of establishing a multimodal application voice by selecting a voice personality for the multimodal application and creating in dependence upon the voice personality a VoiceXML dialog.

Server (151) of FIG. 2 includes non-volatile computer memory (166) coupled through a system bus (160) to processor (156) and to other components of the server (151). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary server (151) of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary server (151) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal applications according to embodiments of the present invention include modems for wired dial-up communications, Ethernet (IEEE 802.3) adapters for wired network communications, and 802.11b adapters for wireless network communications.

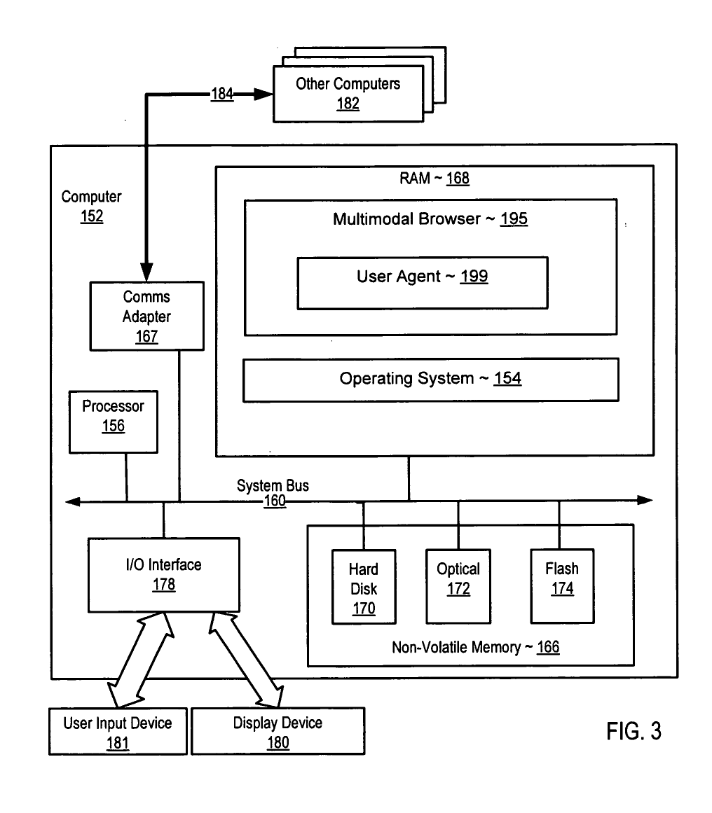

Multimodal markup documents that employ a multimodal application voice according to embodiments of the present invention are generally displayed on multimodal web browsers installed on automated computing machinery. For further explanation, therefore, FIG. 3 sets forth a block diagram of automated computing machinery comprising an exemplary client (152) that supports a multimodal browser useful in displaying multimodal markup documents employing a multimodal application voice in accordance with the present invention.

The client (152) of FIG. 3 includes at least one computer processor (156) or ‘CPU’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5/OS, and many others as will occur to those of skill in the art.

Also stored in RAM (168) is a multimodal browser (195) capable of displaying multimodal markup documents employing a multimodal application voice according to embodiments of the present invention. The exemplary multimodal browser (195) of FIG. 3 also includes a user agent (197) capable of receiving from a user speech and converting the speech to text by parsing the received speech against a grammar. A grammar is a set of words or phrases that the user agent will recognize. Typically each dialog defined by a particular form or menu being presented to a user has one or more grammars associated with the form or menu. Such grammars are active only when the user is in that dialog.

Client (152) of FIG. 3 includes non-volatile computer memory (166) coupled through a system bus (160) to processor (156) and to other components of the client (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary client of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary client (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal browsers according to embodiments of the present invention include modems for wired dial-up communications, Ethernet (IEEE 802.3) adapters for wired network communications, and 802.11b adapters for wireless network communications.

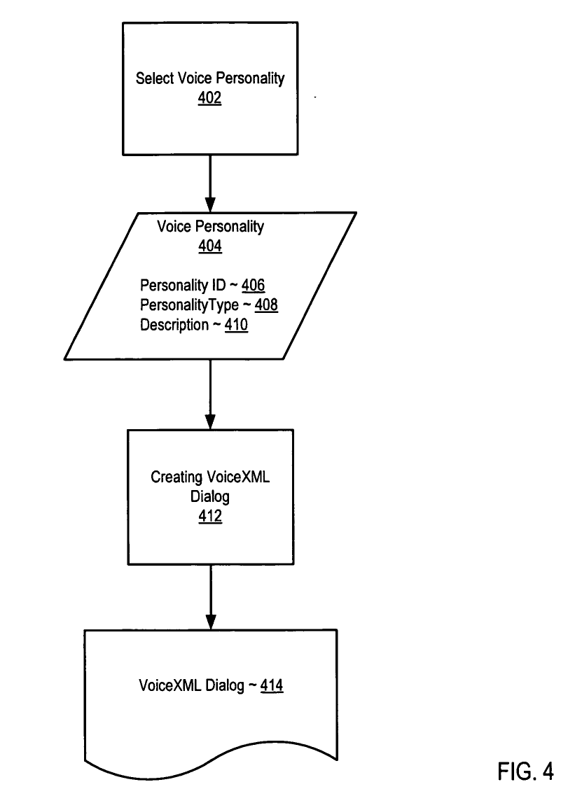

For further explanation, FIG. 4 sets forth a flow chart illustrating an exemplary method for establishing a multimodal application voice. A multimodal voice provides the sound and style of speech output of a multimodal application. Such multimodal voices may advantageously be varied according users, sponsors, and system variables and therefore provide user-friendly interactions with users.

The method of FIG. 4 includes selecting (402) a voice personality (404) for the multimodal application. A voice personality is an established set of characteristics for a particular voice. In the example of FIG. 4, the voice personality is implemented as a voice personality record (404) that represents a particular voice personality. Examples of such a voice personality include ‘a southern woman calling after work hours,’‘an anxious man in a waiting room of a doctor,’‘a teenager after school hours,’‘a polite teenager during school hours’ and so on. The exemplary voice personality record (404) of FIG. 4 includes a personality ID (406) uniquely representing the voice personality.

The exemplary voice personality record (404) of FIG. 4 also includes a personality type (408) that includes a type code for the voice personality. Type codes advantageously provide a vehicle of categorizing various voice personalities. The voice personality record (404) of FIG. 4 also includes a description field (410) containing a description of the voice personality. An example of such a description is ‘Southern woman calling after work hours.’

The method of FIG. 4 includes creating (412) in dependence upon the voice personality (404) a VoiceXML dialog (414). There are two kinds of dialogs in VoiceXML: forms and menus. Voice forms define an interaction that collects values for a set of form item variables. Each form item variable of a voice form may specify a grammar that defines the allowable inputs for that form item. If a form-level grammar is present, it can be used to fill several form items from one utterance. A menu presents the user with a choice of options and then transitions to another dialog based on that choice. Such menus also often have an associated grammar.

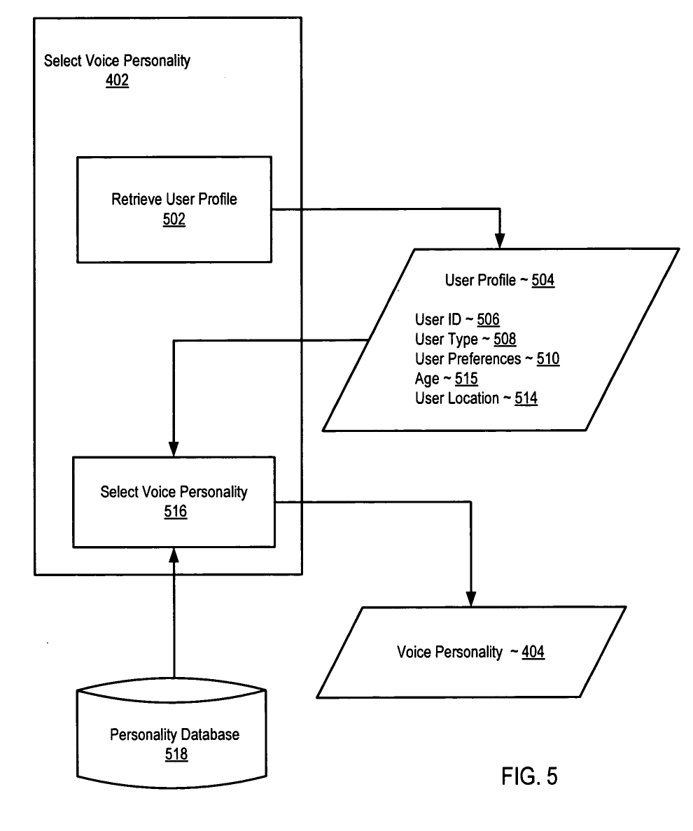

As discussed above, voice personalities may also be selected in dependence upon users. For further explanation, FIG. 5 sets forth a flow chart illustrating an exemplary method for selecting (402) a voice personality (404) for the multimodal application. The method of FIG. 5 includes retrieving (502) a user profile (504) and selecting (516) a voice personality (404) for the multimodal application in dependence upon the user profile (504). Retrieving (502) a user profile (504) may be carried out by retrieving a user profile from a user profile database.

In the example of FIG. 5, a user profile (504) is implemented in data as a user profile record (504) for a user. The exemplary user profile record (504) of FIG. 5 includes a user ID (506) that uniquely identifies the user profile. The exemplary user profile record (504) of FIG. 5 also includes a user type (508) field providing a type code for the user. A user type may be any type designation of a user. Such type designations may include type codes for occupation, gender, national origin, height, organizational affiliation or any other user type. The exemplary user profile of FIG. 5 includes only one type code field. This is for ease of explanation, and not for limitation. In fact, user profiles according to embodiments of the present invention may have many user types that together define a user with increased granularity.

The exemplary user profile record (504) of FIG. 5 includes user preferences (510) containing user preferences for selecting voice personalities for multimodal applications. The exemplary user profile record (504) of FIG. 5 includes an age field (515) disclosing the age of the user.

The exemplary user profile record (504) of FIG. 5 includes user location (514). A user location may be derived from a GPS receiver on a client device displaying multimodal web pages according to embodiments of the present invention. A user location is useful in selecting voice personalities for multimodal applications because users may desire to interact with an application differently at different locations. For example, users may prefer interacting with formal business voice personalities while located in their offices and may prefer interacting with more casual or colloquial voice personalities while located in their homes.

Selecting (516) a voice personality (404) for the multimodal application in the example of FIG. 5 is carried out by selecting a voice personality (404) from a voice personality data base (518) in dependence upon one or more of the fields of the user profile (504). Selecting a voice personality according to the method of FIG. 5 advantageously provides a voice personality directed toward user attributes and therefore may provide a voice personality for the user that is custom tailored for the user.

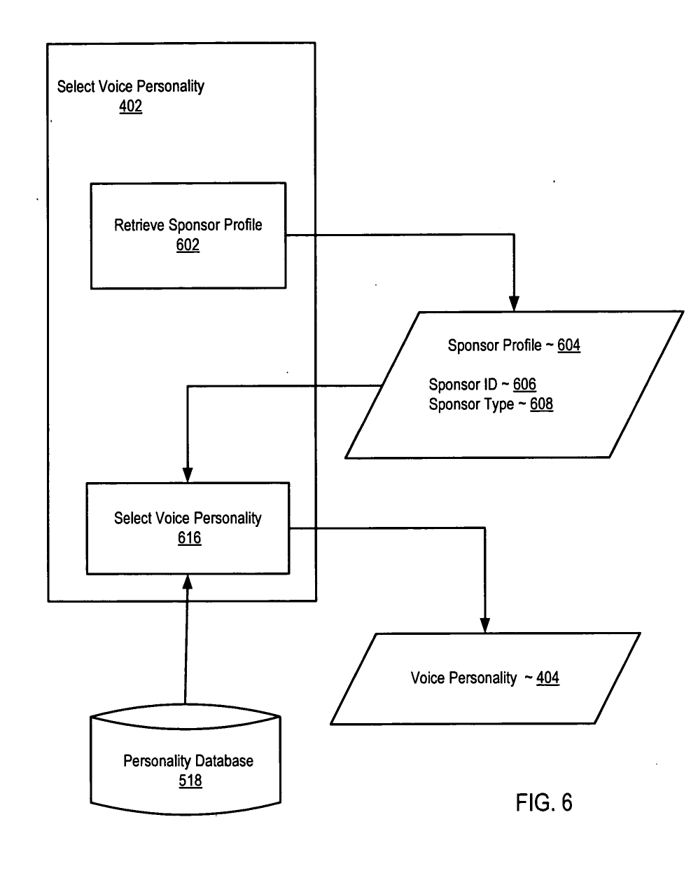

As discussed above, voice personalities may also be selected in dependence upon sponsors. For further explanation, FIG. 6 sets forth a flow chart illustrating an exemplary method for selecting (402) a voice personality (404) for the multimodal application. The method of FIG. 6 includes retrieving (602) a sponsor profile (604) and selecting (616) a voice personality (404) for the multimodal application in dependence upon the sponsor profile (604). A sponsor profile (604) represents a particular paid advertiser or sponsor.

The exemplary sponsor profile of FIG. 6 is represented in data as a sponsor profile record (604). The exemplary sponsor profile record (604) includes a sponsor ID (606) uniquely identifying the sponsor. The exemplary sponsor profile record (604) includes a sponsor type (608). A sponsor type may be any type designation of a sponsor. Such type designations may include type codes for target audience occupation, products or services, size, office locations or any other type of sponsor.

The exemplary sponsor profile of FIG. 6 includes only one type code field. This is for ease of explanation, and not for limitation. In fact, sponsor profiles according to embodiments of the present invention may have many sponsor types that together define a sponsor with increased granularity.

Selecting (616) a voice personality (404) for the multimodal application in the example of FIG. 6 is carried out by selecting a voice personality (404) from a voice personality database (518) in dependence upon one or more of the fields of the sponsor profile (504). Selecting a voice personality according to the method of FIG. 6 advantageously provides a voice personality that has attributes that are sponsor approved or preferred for reaching user.

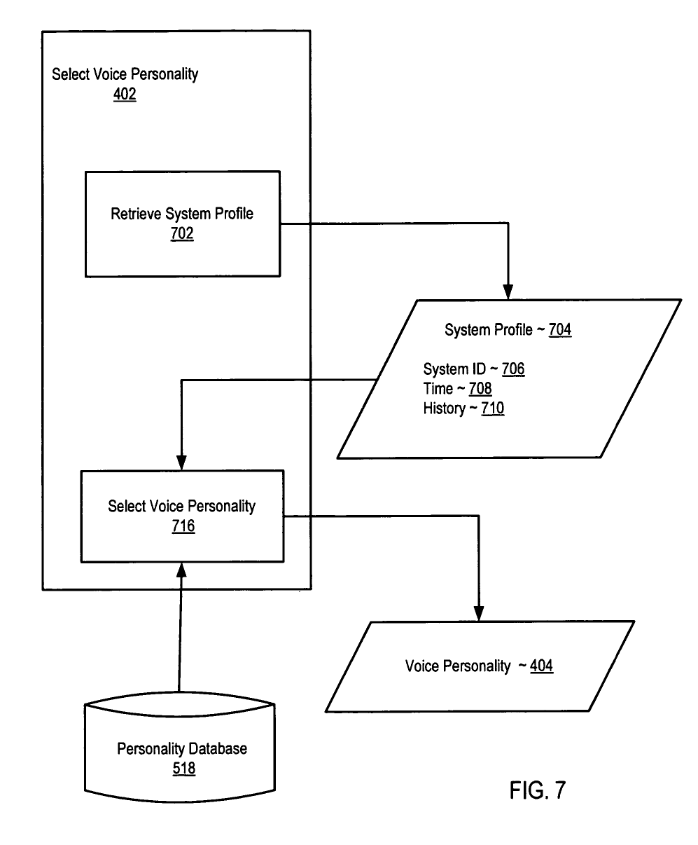

For further explanation, FIG. 7 sets forth a flow chart illustrating an exemplary method for selecting (402) a voice personality (404) for the multimodal application. The method of FIG. 7 includes retrieving (702) a system profile (704) and selecting (716) a voice personality (404) for the multimodal application in dependence upon the system profile (704). A system profiles represents systemic conditions or environment surrounding the user's interaction with the multimodal application.

As discussed above, voice personalities may also be selected in dependence upon system conditions. In the example of FIG. 7, system profile is implemented in data as a system profile record (704). The exemplary system profile record (704) includes a system ID (706) that uniquely identifies the system profile record. The exemplary system profile (704) also includes time field (708) containing the time of day. A time of day is useful in selecting voice personalities for multimodal applications because users may desire to interact with an application differently at different times of the day. For example, users may generally prefer interacting with formal business voice personalities during business hours and may generally prefer interacting with more casual or colloquial voice personalities in the evening. The exemplary system profile record (704) of FIG. 7 also includes a history field (710) containing a history of voice personalities used for various user or for a single user by the multimodal application. A history may also contain historical entries for voice personalities used for ore or more users for one or more multimodal applications having access to the user profile.

Selecting (716) a voice personality (404) for the multimodal application in the example of FIG. 7 is carried out by selecting a voice personality (404) from a voice personality data base (518) in dependence upon one or more of the fields of the system profile (704). Selecting a voice personality according to the method of FIG. 7 advantageously provides a voice personality that is appropriate for the system conditions occurring during while the multimodal application is interacting with the user.

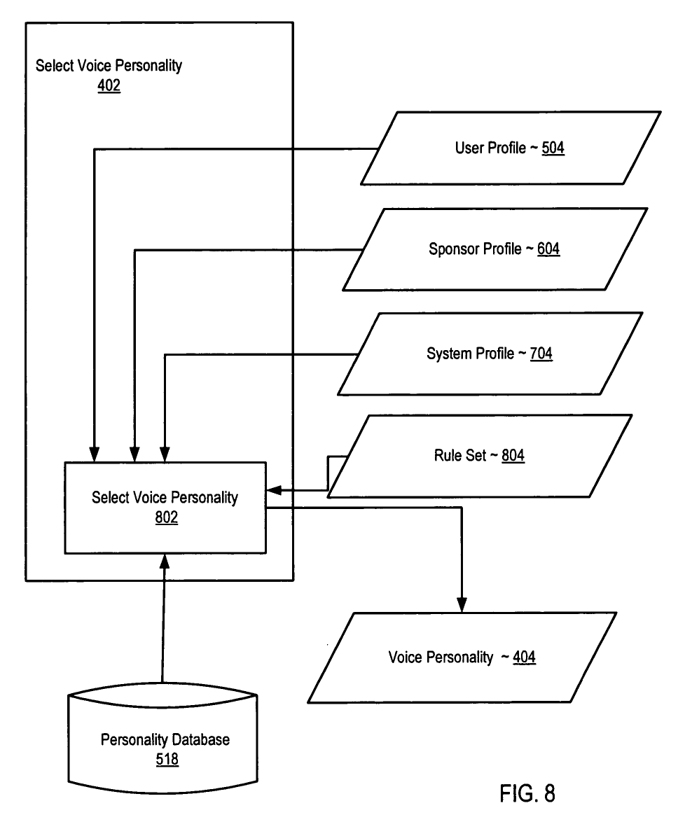

In the examples of FIGS. 5-7, a voice personality is selected in dependence upon a user profile, a sponsor profile, or a system profile individually. This is for explanation, and not for limitation. For further explanation, FIG. 8 sets forth a flow chart illustrating another method of selecting (402) a voice personality (404) for the multimodal application that includes selecting (802) a voice personality (404) for the multimodal application in dependence upon one or more attributes of a user profile (504), a sponsor profile (604), and a system profile (704).

In the example of FIG. 8, selecting (802) a voice personality (404) for the multimodal application is carried out by retrieving a voice personality from a voice personality database (518) in dependence upon zero, one, more attributes of the user profile (504), the sponsor profile (604), and the system profile (704) according to a rule set (804). A rule set (804) governs the selection of a voice personality by providing specific rules for retrieving the voice personality form the voice personality database in dependence upon the attributes of the user profile, sponsor profile and system profile. Consider the following example rule:

If user type = lawyer; and
User type = female; and
Day = weekday; and
Time = 9:00 am; then

Select voice personality = female business voice.

In the example above, a voice personality for a female business voice is selected according to the method of FIG. 8 for a user who is a lawyer and is female at 9:00 on a weekday. The method of FIG. 8 advantageously provides for selection of voice personalities that are user friendly, sponsor approved, and system compatible.

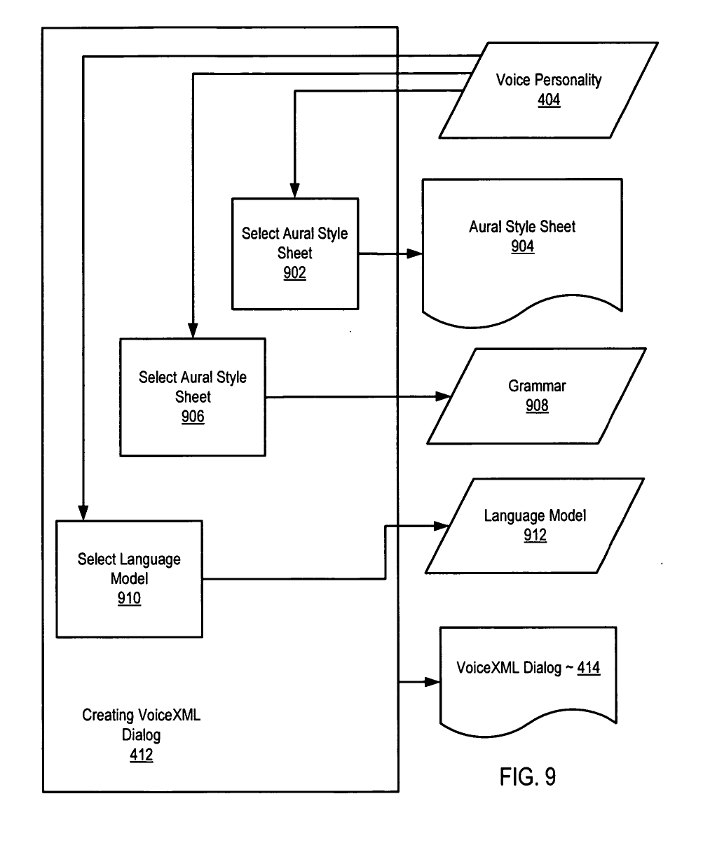

For further explanation, FIG. 9 sets forth a flow chart illustrating an exemplary method for creating (412) in dependence upon the voice personality (404) a VoiceXML dialog (414). As discussed above, there are two kinds of dialogs in VoiceXML: forms and menus. Voice forms define an interaction that collects values for a set of form item variables. Each form item variable of a voice form may specify a grammar that defines the allowable inputs for that form item. If a form-level grammar is present, it can be used to fill several form items from one utterance. A menu presents the user with a choice of options and then transitions to another dialog based on that choice. Such menus also often have an associated grammar.

The method of FIG. 9 also includes selecting (902) in dependence upon the voice personality (404) an aural style sheet (904). An aural style sheet includes markup defining the sound and style of voice output of a multimodal application. Such aural style sheets are often stored externally. Aural style sheets may be cascading because more than one aural style sheet may control the voice output of a dialog of a multimodal web page. Aural style sheets provide markup to direct the volume of the speech output of a dialog, the gender of the voice, the speech rate of the voice, stressing of particular words or syllables of the voice and so on as will occur to those of skill in the art. Aural style sheets useful in creating a VoiceXML dialog according to embodiments of the present invention may include cascading style sheet (‘CSS’) as described in the Cascading Style Sheets level 2 CSS2 Specification available at http://www.w3.org/TR/REC-CSS2/.

Selecting (902) in dependence upon the voice personality (404) an aural style sheet (904) may be carried out by selecting an aural style sheet from an aural style sheet database (not shown) having aural style sheets indexed by voice personality ID. An aural style sheet is then selected in dependence upon the voice personality ID to select a sound and style for a voice tailored to the voice personality.

The method of FIG. 9 also includes selecting (906) in dependence upon the voice personality (404) a grammar (908). A grammar is a set of words or phrases that a voice recognition engine will accept. Typically each dialog defined by a particular form or menu being presented to a user has one or more grammars associated with the form or menu. Such grammars are active only when the user is in that dialog.

Selecting (902) in dependence upon the voice personality (404) a grammar (908) may be carried out by selecting a grammar from a grammar database (not shown) having grammars indexed by voice personality ID. A grammar is then selected in dependence upon the voice personality ID to select a grammar tailored to the voice personality.

The method of FIG. 9 also includes selecting (910) in dependence upon the voice personality (404) a language model (912). A language model provides syntax for interpreting the words defined in a grammar. One such language model useful in embodiments of the present invention is the Ngram language model. jAn N-Gram grammar is a representation of a Markov language model in which the probability of occurrence of a symbol, such as a word, a pause or other event, is conditioned upon the prior occurrence of other symbols. N-Gram grammars are typically constructed from statistics obtained from a large corpus of text using the co-occurrences of words in the corpus to determine word sequence probabilities. N-Gram grammars are able to administer larger grammars. Further information about N-Gram grammars is available in the Stochastic Language Models (N-Gram) Specification available at http://www.w3.org/TR/ngram-spec.

Selecting (910) in dependence upon the voice personality (404) a language model (912) may be carried out by selecting a language model from a language model database (not shown) having language model IDs indexed by voice personality ID. An appropriate language model is then selected in dependence upon the voice personality ID to select a language model appropriately directed to the voice personality.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for establishing a multimodal application voice, the method comprising;
selecting a voice personality for the multimodal application; and
creating in dependence upon the voice personality a VoiceXML dialog.

2. The method of claim 1 wherein selecting a voice personality for the multimodal application further comprises retrieving a user profile and selecting a voice personality for the multimodal application in dependence upon the user profile.

3. The method of claim 1 wherein selecting a voice personality for the multimodal application further comprises retrieving a sponsor profile and selecting a voice personality for the multimodal application in dependence upon the sponsor profile.

4. The method of claim 1 wherein selecting a voice personality for the multimodal application further comprises retrieving a system profile and selecting a voice personality for the multimodal application in dependence upon the system profile.

5. The method of claim 1 wherein creating in dependence upon the voice personality a VoiceXML dialog further comprises selecting in dependence upon the voice personality an aural style sheet.

6. The method of claim 1 wherein creating in dependence upon the voice personality a VoiceXML dialog further comprises selecting in dependence upon the voice personality a grammar.

7. The method of claim 1 wherein creating in dependence upon the voice personality a VoiceXML dialog further comprises selecting in dependence upon the voice personality a language model.

8. A system for establishing a multimodal application voice, the system comprising;
a computer processor;
a computer memory coupled for data transfer to the processor, the computer memory having disposed within it computer program instructions comprising:
a voice engine capable of:
selecting a voice personality for the multimodal application; and
creating in dependence upon the voice personality a VoiceXML dialog.

9. The system of claim 8 wherein the voice engine is further capable of retrieving a user profile and selecting a voice personality for the multimodal application in dependence upon the user profile.

10. The system of claim 8 wherein the voice engine is further capable of retrieving a sponsor profile and selecting a voice personality for the multimodal application in dependence upon the sponsor profile.

11. The system of claim 8 wherein the voice engine is further capable of retrieving a system profile and selecting a voice personality for the multimodal application in dependence upon the system profile.

12. The system of claim 8 wherein the voice engine is further capable of selecting in dependence upon the voice personality an aural style sheet.

13. The system of claim 8 wherein the voice engine is further capable of selecting in dependence upon the voice personality a grammar.

14. The system of claim 8 wherein the voice engine is further capable of selecting in dependence upon the voice personality a language model.

15. A computer program product for establishing a multimodal application voice, the computer program product disposed upon a recording medium, the computer program product comprising:
computer program instructions that select a voice personality for the multimodal application; and
computer program instructions that create in dependence upon the voice personality a VoiceXML dialog.

16. The computer program product of claim 15 wherein computer program instructions that select a voice personality for the multimodal application further comprise computer program instructions that retrieve a user profile and computer program instructions that select a voice personality for the multimodal application in dependence upon the user profile.

17. The computer program product of claim 15 wherein computer program instructions that select a voice personality for the multimodal application further comprise computer program instructions that retrieve a sponsor profile and computer program instructions that select a voice personality for the multimodal application in dependence upon the sponsor profile.

18. The computer program product of claim 15 wherein computer program instructions that select a voice personality for the multimodal application further comprise computer program instructions that retrieve a system profile and computer program instructions that select a voice personality for the multimodal application in dependence upon the system profile.

19. The computer program product of claim 15 wherein computer program instructions that create in dependence upon the voice personality a VoiceXML dialog further comprise computer program instructions that select in dependence upon the voice personality an aural style sheet.

20. The computer program product of claim 15 wherein computer program instructions that create in dependence upon the voice personality a VoiceXML dialog further comprise computer program instructions that select in dependence upon the voice personality a grammar.
